(19) United States
(12) Patent Application Publication
(10) Pub. No.: US 2009/0024716 A1
(43) Pub. Date: Jan. 22, 2009

(54) Virtual Storage of a User's duplicate personal MP3 Audio/Video File Collection

(76) Inventor: William Earl Reynolds, JR., Spring, TX (US)

Correspondence Address: J. B. Kraft, #5C, 710 Colorado Street, Austin, TX, 78701, US

(21) Appl. No.: 11/780,247

(22) Filed: Jul. 19, 2007

(51) Int. Cl. G06F 15/16

(52) U.S. Cl. 709/217

(57) ABSTRACT

A computer controlled implementation for selecting and accessing MP3 audio/video files on the World Wide Web, including a basic computer enabling a user to select and access MP3 files from a MP3 file source on a network, and storage apparatus for storing these accessed MP3 files as a user personal MP3 collection in association with the basic computer. Further apparatus are responsive to the accessing of each of the MP3 files for also transmitting a duplicate of each accessed file to a virtual storage site on the Web where the duplicate MP3 files are stored as a virtual duplicate user personal MP3 collection.

### TECHNICAL FIELD

The present invention relates to the playing of audio/video files on MP3 players, and particularly to the storage and easy access of a user to the large quantities of such MP3 files that the user has acquired from MP3 file providers and accumulated into his user personal MP3 collection or library.

### BACKGROUND OF RELATED ART

Over the past decade, the consumer electronics industry has witnessed an unprecedented demand for MP3 audio/video players and the titles or MP3 files playable in sets or sequences on such players. By titles or MP3 files is meant recorded audio/video presentations from two or three minute tunes or units up to and including, usually, album sized recordings in the order of one hour in length. In the current market, the emphasis is on audio, e.g. musical presentations. Accordingly, the present state of the art and Applicants invention will be illustrated in audio embodiments of MP3 music files. However, it should be understood that all of the principles of operation discussed herein are equally applicable to video MP3 presentations. In such video presentations, the individual MP3 files are greater in size.

MP3 is shorthand for MPEG, Level 3. MP3 is, to a great extent, replacing the compact disc as today's reigning music distribution standard with dozens of MP3 player devices saturating the consumer marketplace. MP3 is a standard about which an industry has been gathered. MP3 takes advantage of the high compression afforded under the MPEG audio standard and uses it as the basis for a file system that serves as a standard for today's MP3 hardware. The advantage of MP3 is compression. For example, it fits audio files into about 1/20 of the space raw digital audio would require. As a result, music that would nominally require a 50 MB file under the WAV format only takes about 1-2 MB. Smaller files mean less transmission time so that entire albums can reasonably be sent across the Internet or Web. In solid state memory MP3 players, substantial lengths of music (a few hours or more) may be encoded into the solid state memory and carried about in a no moving parts player, such as the iPod™. It is these solid memory players that are today's MP3 music title portable players. Better still, by squeezing the size of the MP3 file, the data rate required for playing back a file in real time can be similarly reduced. Instead of requiring the approximately 1.2 mbits/sec to move two CD quality audio channels, MP3 files need only 40 kbits/sec for near CD quality playback. In the most popular MP3 players, the MP3 music titles or files are currently stored in solid state memories with a capacity in the order of 1-2 gigabyte (GB) that equates to about 240 tunes or songs or about twenty CDs.

All of this great capacity for music files or titles has led to a societal change in the way in which music is accumulated and listened to by a major segment of the population, particularly the younger segment of the population that is conventionally the segment with the greatest purchasing power. The MP3 player technology has provided its users the ability to easily organize and navigate through great numbers of MP3 files. This has led to a great industry wherein MP3 files or title providers enable users to access and acquire large navigatable personal collections or libraries of MP3 files at relatively small or nominal costs. The continuous acquisition of MP3 music files and upgrading of user personal MP3 file collections has become a major recreational pastime.

It is a conventional practice for a user of a MP3 player to have an associated and correlated basic computer that is frequently the user's personal or desktop computer. The large personal collection of MP3 files that many users have accumulated usually exceeds the limited storage capacity of the MP3 player. The user's personal collection is stored at, or in association with, a basic user desktop computer.

The MP3 player, e.g. an ipod™, is connected to and synchronized with a desktop computer, which, in turn, is connected to the Web through which the user may access and acquire new MP3 files from a MP3 audio/video file provider. The connection between MP3 player and basic desktop computer is conventionally a high speed FireWire™ or USB 2.0 connection. The connection to the basic user desktop is described in greater detail at pp. 162-163 of the text, ipod™+iTunes™ for Windows™ and Mac™ in a Snap, Brian Tiemann, Sams Publishing, Indianapolis, Ind., 2006. The synchronization and loading between the computer and the MP3 player is described in Chapter 6, pp. 161-198 of the text.

The 1-2 gigabyte capacity of the standard MP3 player usually holds only a small portion of the user personal MP3 collection. As a result, the user is in effect tethered to his correlated basic desktop or personal computer should the user wish to change MP3 files stored in the collection portion of his player. Since our society is increasingly mobile and the segment of society using MP3 players is particularly mobile, there is a desire on the part of users of MP3 players for greater flexibility in the accessing of their personal collections of MP3 audio/video files.

### SUMMARY OF THE PRESENT INVENTION

The present invention provides an implementation that addresses the problem of user access to personal collections of MP3 files that not only enables a user of a MP3 player to more readily access his personal collection but also protects his personal collection against destruction or corruption of his personal collection stored at the basic personal or desktop computer.

Accordingly, the present invention provides a computer controlled system for selecting and accessing MP3 audio/video files over a network, such as the World Wide Web (Web), that comprises the combination of a first or basic computer enabling a user to select and access MP3 files from a MP3 file source on a network and storage apparatus for storing these accessed MP3 files as a user personal MP3 collection in association with the first computer. The invention further provides apparatus, responsive to the accessing of each of said MP3 files for also transmitting a duplicate of each accessed file to a virtual storage site on the network (Web) where the duplicate MP3 files are stored as a virtual duplicate user personal MP3 collection.

In this system, the device for playing audio/video MP3 files, the MP3 player includes apparatus enabling the user to access a selected portion of MP3 files either: from the personal collection through first or basic computer; or from the virtual duplicate personal collection through an alternate computer; as well as the apparatus for storing this selected portion of the MP3 personal collection.

For best results, the duplicates of any MP3 files accessed from a source, such as a MP3 provider on the Web, are transmitted to the virtual storage site automatically in response to the accessing of the files from the source.

As will hereinafter be described in greater detail, the device for playing the MP3 files may include the above-mentioned alternate computer.

In another aspect of the invention, the MP3 player is capable of accessing the virtual duplicate user personal MP3 collection through any computer having access to the Web that will function as the alternate computer.

In accordance with still another aspect of the invention, the virtual duplicate user personal collection is administered and controlled by a virtual storage service provider controlling a system that includes a set of one or more virtual storage sites on the Web, as well as the above-described apparatus that, in response to the accessing of each of the selected MP3 files, automatically transmits a duplicate of each accessed file to a selected one of the set of virtual storage sites on the Web wherein duplicate MP3 files are stored as a virtual duplicate user personal MP3 collection distributed among the set of virtual storage sites. The virtual provider may also track the distribution of the duplicate user collection among the set of virtual storage sites and the activity of the user accessing the MP3 files. The MP3 file provider may, under appropriate circumstances, also be the virtual storage provider.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a network (Web) portion including a MP3 player connected to a desktop or alternately connected to another computer for respectively accessing the user personal MP3 file collection or the virtual duplicate user personal MP3 file collection;

FIG. 2 is a generalized diagrammatic view of a system like that of FIG. 1 but that MP3 player is also a wireless mobile cellular telephone, like the iphone™ that includes the player, as well as an alternate computer;

FIG. 3 is a block diagram of a data processing system including a central processing unit and network connections via a communications adapter that functions as the (basic) desktop computer through which a connected MP3 player may access new MP3 files from the Web and transmit duplicates of accessed MP3 files to virtual storage sites;

FIG. 4 is an illustrative flowchart describing the setting up of the programming functions to form the implementation of the present invention for the establishment and maintenance of virtual duplicate user personal MP3 collections, and the accessing of portions of these virtual user personal collections; and

FIG. 5 is a flowchart of an illustrative run of the program set up according to FIG. 4.

### DETAILED DESCRIPTION OF THE PREFERRED EMBODIMENT

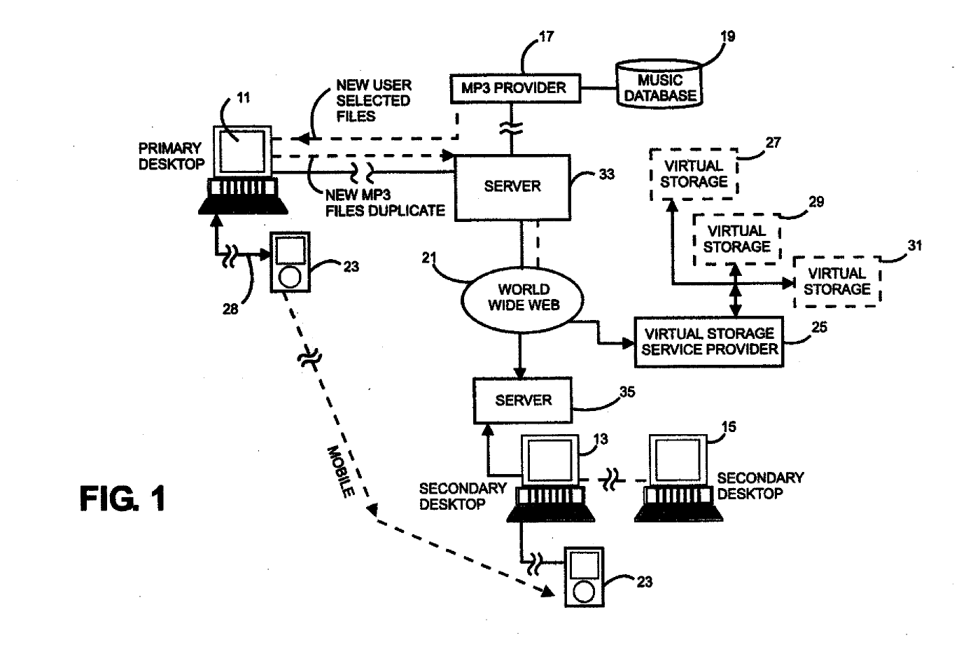

Referring to FIG. 1, a generalized example of the practice of the present invention involves a portion of the Web that serves as the illustrative communication network in this embodiment. MP3 player 23, e.g. an iPod™, is connected to and synchronized with desktop computer 11 that, in turn, is connected to the Web 21 through its Web server 33 so that a user of computer 11 may navigate on the Web 21 under the control of any conventional Web browser program in the desktop 11. The connection 28 of the MP3 player to the basic desktop computer 11 is a high speed FireWire™ or USB 2.0 connection. The connection to the desktop is described in greater detail at pp. 162-163 of the above-referenced text, iPod™+iTunes™ for Windows™ and Mac™ in a Snap.

While connection 28 between MP3 playing device 23 and basic computer 11 has been shown as a wired connection, the connection may also be wireless. Such a wireless MP3 player is wirelessly connected to basic desktop computer 11. Each of MP3 player 23 and basic computer 11 that would have to include a short range RF transceiver. This wireless access operates under 802.11 protocols. Such wireless connections are described in the above-referenced text, iPod™+iTunes™ for Windows™ and Mac™ in a Snap, at pp. 228-231.

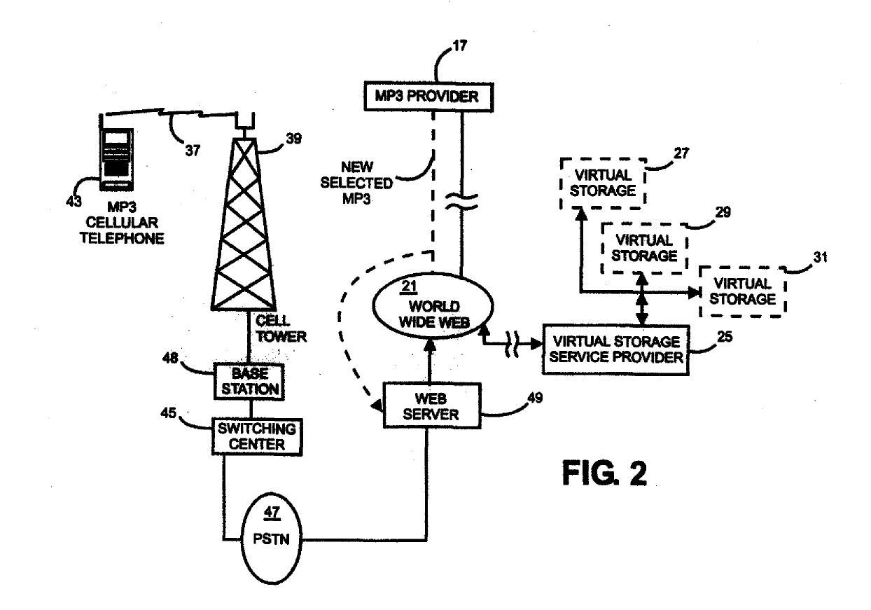

The advanced enabling of the above-described short range wireless connections have been facilitated by the development of the industry standard IEEE 802.11 through the most current 802.15.1 (Bluetooth) short range RF protocols. The IEEE 802.11 through 802.15 wireless transmission protocols are discussed in greater detail at pp. 60-62 in the text, Peter Norton's Complete Guide to Networking, SAMS Division of MacMillan Computer Publishing, Indianapolis, Ind., 1999, pp. 49-62, as well as in the article, A Wireless Local Area Network Protocol That Improves Throughput Via Adaptive Control, B. E. Mullins et al., Proceedings of the IEEE International Conference on Communications, pp. 1427-1431, June 1997. The short range transmissions can operate within facility areas of from 10 to 100 meters in diameter from a central or optimally located facility transceiver. Such a wireless connection between the MP3 player 23 and basic desktop computer 11 would be particularly valuable where, as will hereinafter be described with respect to FIG. 2, the MP3 player is included in a general purpose wireless device such as a cellular telephone.

The synchronization and loading between the computer 11 and the MP3 player 23 is described in Chapter 6, pp. 161-198, of the above-referenced Tiemann text. In accordance with standard practice in the acquisition of MP3 audio/video files, the user, through the basic or primary desktop computer, accesses from the Web and via the computer browser program a typical MP3 audio/video file provider, e.g. provider 17 accessed via the Web 21 through Web server 33. The user selects from provider 17 offerings from the MP3 provider's MP3 database, e.g. music file database 19. The new MP3 files selected by the user are transmitted back as indicated in FIG. 1 through Web 21 and server 33. The selected MP3 files are stored in the storage apparatus of basic or primary desktop computer as the user's personal MP3 file collection. Then, when the user wishes to access or modify the portion of his overall stored personal collection that he wishes to store on his MP3 player 23, he connects the MP3 player 23 with the primary or basic computer 11 and accesses his stored user personal MP3 collection through the synchronized connections described above. Thus, the user is dependent on only the personal collection stored on computer 11 for his MP3 files.

Now, in accordance with the present invention, provision is made for a duplicate virtual user personal collection stored in virtual storage somewhere on the Web as determined by a virtual storage service provider 25. In the operation of this invention, whenever a new MP3 file for the user personal collection is accessed at the basic computer 11 from MP3 provider 17, a duplicate of the MP3 file is sent as indicated via server 33 and Web 21 to virtual storage provider 25 that controls the establishment and maintenance of a virtual duplicate user personal MP3 collection corresponding to the user personal collection stored on basic computer 11. The sending of a duplicate MP3 file may be set up so that whenever an accessed MP3 file is received at the basic computer 11 for the user personal MP3 file collection, a duplicate of the file is automatically sent to the virtual storage. Virtual storage service provider 25 controls and tracks the virtual duplicate user personal collection that the provider may distribute among several virtual storage sites 27, 29 and 31 that may be spread over several Web locations. As an alternative to the automatic sending of a duplicate file to the virtual storage, a process may be set up as follows. Whenever a new accessed MP3 file is received, the user, at the first or primary computer receiving the new file is prompted via the computer display to, e.g. 1) send a duplicate to virtual storage now; 2) do not send a duplicate, or 3) send a duplicate later. The virtual storage service provider usually charges a fee for maintaining and controlling the virtual duplicate personal collection. It should be noted that the MP3 provider 17 function and the virtual storage service provider 25 function may be carried out by the same service provider organization.

One major advantage of the present invention is that a very valuable personal user MP3 file collection would not be in jeopardy of loss due to the crashing, destruction, theft or corruption of the storage drive of the basic computer 11. However, there is a greater advantage to the mobile user of the MP3 player. When the user moves the player to a location remote from the basic computer 11, as indicated in FIG. 1, by the movement of MP3 player 23 to a location near another computer, e.g. alternate secondary computer 13 or computer 15, the MP3 player 23 may connect or dock into the secondary computer, and through the Web access of this secondary computer via server 35, access Web 21, and thereby the virtual duplicate user collection controlled by virtual storage service provider 25.

In accordance with another aspect of this invention, as indicated in FIG. 2, the alternate or secondary computer may be incorporated in the MP3 player device itself. For example, the newly announced iphone™ that is a wireless cellular telephone including a MP3 player among several other functions has an incorporated computer with sufficient data processing function and memory, up to eight gigabytes, to function as the alternate computer through which the virtual duplicate user personal MP3 collection may be accessed. In FIG. 2, a wireless cellular telephone 43, e.g. an iPhone™, including both the MP3 player and a computer, i.e. that functions as the alternate computer, transmits and receives wirelessly 37 through the closest cellular tower 39 connected through base station 48 and appropriate “ground wired” conventional telephone switching center 45 into the PSTN (Public Switched Telephone Network) through a selected Web server 49 into the Web 21 through which, as previously described with respect to FIG. 1, the alternate computer in MP3 player/cellular telephone 43 may access the virtual duplicate user personal collection through virtual storage service provider that controls the accessing and distribution of the duplicate user collection over a plurality of virtual storage sites 27, 29 and 31.

It should be noted that the MP3 player in the cellular telephone 43 could also directly access the MP3 file provider 17 via the cellular telephone route described above and acquire new MP3 files. However, since it would be most effective to still maintain the user personal MP3 file collection stored on a primary computer, such as desktop computer 11 in FIG. 1, any new MP3 files that cellular MP3 player 43 acquires would have to be filed in the user personal collection stored on computer 11. Although not shown in FIG. 2, there may be a basic computer, such as computer 11, to which the cellular MP3 player 43 may be connected either through the described direct or wireless connections. When cellular MP3 player 43 is, thus, connectable to a basic or primary computer on which the full user personal MP3 collection is stored, any new MP3 files that the player 43 has acquired will be correlated into the user personal MP3 collection stored on the basic computer through the Bluetooth wireless connection and the synchronization functions described hereinabove with respect to FIG. 1. Since duplicates of all new MP3 files added to the user personal collection must also be transmitted to the virtual storage service provider 31 for the duplicate collection, it is most efficient for such duplicates to be sent when the new MP3 files acquired by the cellular MP3 player 43 are correlated into the user personal collection on the basic computer.

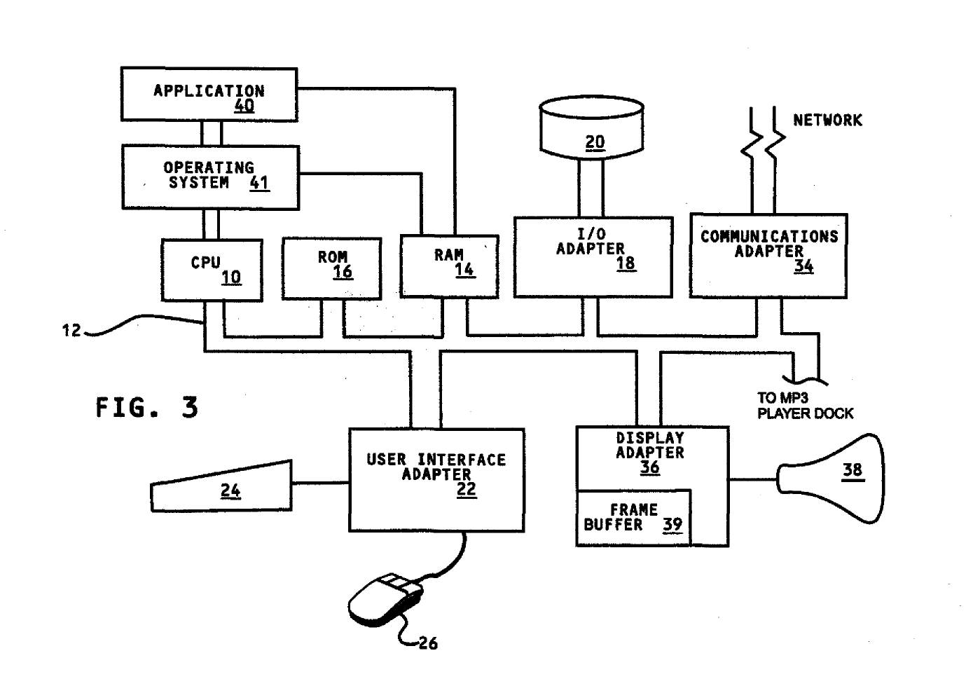

A typical computer that may be used in the practice of the invention for the primary desktop computer 11 or any of the servers shown in FIGS. 1 and 2 will be described with respect to FIG. 3. A central processing unit (CPU) 10, such as one of the PC microprocessors or workstations available from HP Inc. (Hewlett-Packard) or Dell PC microprocessors, is provided and interconnected to various other components by system bus 12. An operating system 41 runs on CPU 10, provides control and is used to coordinate the function of the various components of the computers and servers of FIGS. 1 and 2. Operating system 41 may be one of the commercially available operating systems, such as Microsoft's WindowsXP™, as well as UNIX and other operating systems. Application programs 40, controlled by the system, are moved into and out of the main memory Random Access Memory (RAM) 14. These programs include programs of the present invention and the Web browser through which the MP3 provider and the virtual storage service provider may be accessed to acquire new MP3 files and to virtually store such MP3 files in the virtual duplicate user personal collections.

A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage drive 20. Communications adapter 44 interconnects bus 12 with an outside network, e.g. the Web. Bus 12 is also connected to the MP3 player dock connectors, e.g. FireWire™ or USB 2.0, or wirelessly via Bluetooth short range RF protocols. Keyboard 24 and mouse 26 are all interconnected to bus 12 through user interface adapter 22. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

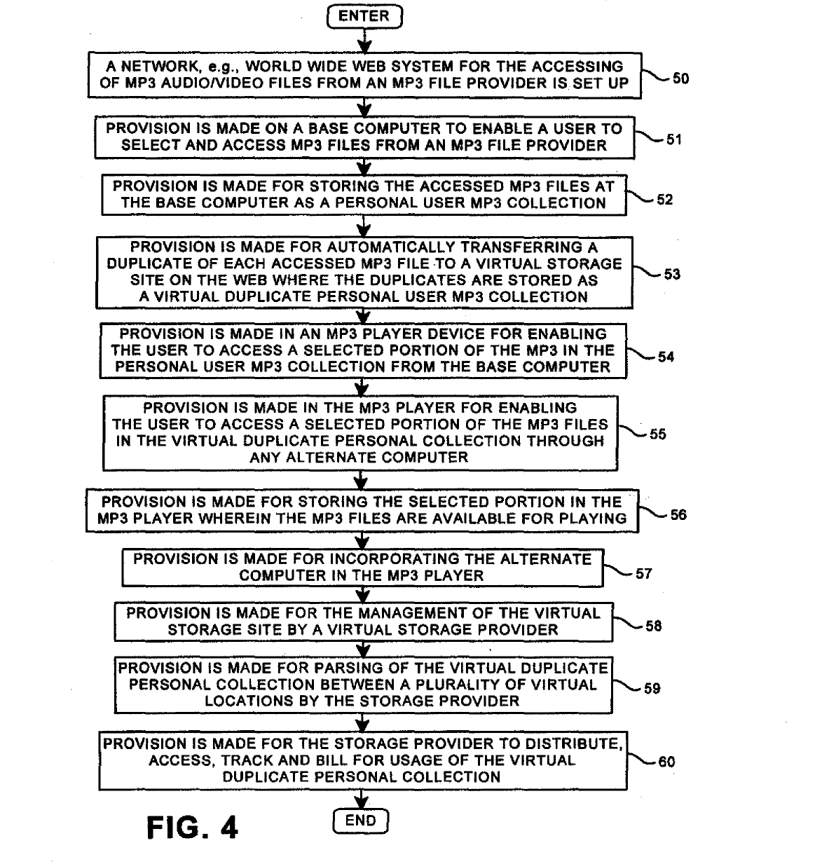

Now, with reference to the programming shown in FIG. 4, there will be described how the system and programs of the present invention are set up. In a network such as the Web, a system is set up for the accessing of MP3 audio/video files from a MP3 file provider, step 50. Provision is made on a basic computer to enable a user to select and access MP3 files from the MP3 provider, step 51. Provision is made for the storing of the accessed MP3 files at the base computer as a personal user MP3 collection, step 52. Provision is made for automatically transferring a duplicate of each accessed MP3 file to a virtual storage site on the Web where the duplicates are stored as a virtual duplicate personal user MP3 collection, step 53. Provision is made in a MP3 player for enabling the user to access a selected portion of the MP3 files in the personal collection from the base computer, step 54. Provision is made in the MP3 player for enabling the user to access a selected portion of the MP3 files in the virtual duplicate personal collection through any alternate computer, step 55. Provision is made for the storing of the selected portion in the MP3 player, wherein the MP3 files are available for playing, step 56. Provision is made for incorporating the alternate computer into the MP3 player, step 57. Provision is made for the management of the virtual site by a virtual storage provider, step 58. Provision is made for the parsing of the virtual duplicate personal collection between a plurality of virtual storage locations by the virtual storage provider, step 59. Provision is made for the virtual storage provider to distribute, access, track and bill for usage of the virtual duplicate user personal collection, step 60.

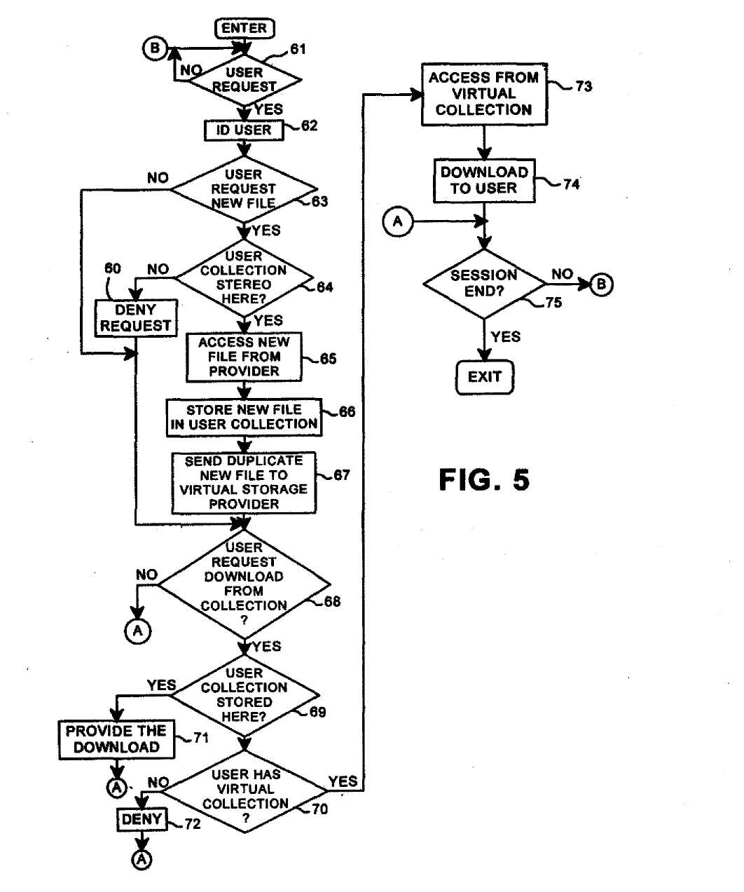

With reference to the flowchart of FIG. 5, a simplified illustrative run of the process set up in FIG. 4 will be described. At the basic user computer that may be operatively associated with the MP3 player for the correlation of the user personal MP3 collection, and transfer of MP3 files to the player, a user logon for the ordering of a new MP3 file for the user personal collection is awaited, step 61. If Yes, the user is identified, step 62, after which a determination is made as to whether the user has requested a new MP3 file, step 63. If Yes, a further determination is made as to whether the user has his personal collection stored at this basic, e.g. desktop computer, step 64. If No, the request for a new MP3 is denied, step 60. If the determination at step 64 is Yes, the new MP3 file is accessed from the provider, step 65, and added to the stored user personal MP3 collection at the basic computer, step 66. Automatically, a duplicate of the new file is sent to the virtual storage service provider for addition to the user's virtual duplicate MP3 collection managed by the storage provider, step 67. At this point, or if the determination at either decision steps 63 or 64 is No, a further determination is made as to whether the user has requested a download from his personal collection, step 68. If Yes, there is a next determination, step 69, as to whether the user's personal collection is stored at this basic computer. If Yes, the download is provided for a portion of the user MP3 file collection to the user MP3 player, step 71. If No, then a further determination is made, step 70, as to whether the user has a virtual duplicate MP3 collection stored with a virtual storage provider. If No, the request is denied, step 72. However, if Yes, then this computer now serves as the alternate or secondary computer wherein the requested portion of MP3 files is accessed from the virtual duplicate user personal MP3 collection 73 and downloaded to the user's MP3 player, step 74. At this point, or after steps 71 or 72 branched to this point via branch “A”, a determination may conveniently be made as to whether the session is over, decision step 75. If Yes, the session is exited. If No, then the process is returned to initial step 61 via branch “B”.

While this invention has been described using audio and video examples of MP3 files, it should be understood that the present invention is also applicable to and intended to cover MP3 files of still images, such as photographs, as well as sequences of such still images.

One of the preferred implementations of the present invention is in application program 40, i.e. a program made up of programming steps or instructions for accessing portions of the entire file, as well as the accessing of the entire digital file, resident in RAM 14, FIG. 3, of a Web receiving station and/or Web server during various Web operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a network, such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A computer controlled system for selecting and accessing MP3 audio/video files over a network comprising:
a first computer enabling a user to select and access MP3 files from a MP3 file source on a network;
storage apparatus for storing said accessed MP3 files as a user personal MP3 collection in association with said first computer;
apparatus responsive to the accessing of each of said MP3 files for also transmitting a duplicate of each accessed file to a virtual storage site on the network where duplicate MP3 files are stored as a virtual duplicate user personal MP3 collection; and
a device for playing said audio/video MP3 files including:
apparatus enabling said user to access a selected portion of MP3 files from said personal collection through first computer or from said virtual duplicate personal collection through an alternate computer; and
apparatus for storing said selected portion of said MP3 files.

2. The system of claim 1 wherein said duplicates of said accessed MP3 files are transmitted to said virtual storage site automatically in response to the accessing of said files from said network source.

3. The system of claim 1 wherein said device for playing said MP3 files includes said alternate computer.

4. The system of claim 2 wherein said network is the World Wide Web.

5. The system of claim 4 wherein said alternate computer is any computer having access to the World Wide Web.

6. The system of claim 4 further including a virtual storage service provider controlling a system including:
a set of one or more virtual storage sites on the Web; and
said apparatus responsive to the accessing of each of said MP3 files for automatically transmitting a duplicate of each accessed file to a selected one of said set of virtual storage sites on the Web wherein said duplicate MP3 files are stored as a virtual duplicate user personal MP3 collection among said set of virtual storage sites.

7. The system of claim 6 wherein said virtual storage provider controlled system further includes apparatus for tracking the distribution of said duplicate user collection among said set of virtual storage sites, and the activity of said user accessing said MP3 files.

8. The system of claim 7 wherein:
said MP3 file source is a MP3 file provider on the Web; and
said MP3 file provider is also said virtual storage provider.

9. A computer controlled method for selecting and accessing MP3 audio/video files over a network comprising:
enabling a user, via a first computer, to select and access MP3 files from a MP3 file source on a network;
storing said accessed MP3 files as a user personal MP3 collection in association with said first computer;
responsive to the accessing of each of said MP3 files, also transmitting a duplicate of each accessed file to a virtual storage site on the network and storing said duplicate MP3 files at said site as a virtual duplicate user personal MP3 collection; and
playing said audio/video MP3 files on a MP3 player including:
enabling said user to access a selected portion of MP3 files from said personal collection through first computer or from said virtual duplicate personal collection through an alternate computer; and
storing said selected portion of said MP3 files on said MP3 player.

10. The method of claim 9 wherein said duplicates of said accessed MP3 files are transmitted to said virtual storage site automatically in response to the accessing of said files from said network source.

11. The method of claim 10 wherein said step of playing said MP3 files includes enabling said user to access a selected portion of MP3 files from said personal collection through an alternate computer included in said MP3 player.

12. The method of claim 9 wherein said network is the World Wide Web.

13. The method of claim 12 wherein said alternate computer is any computer having access to the World Wide Web.

14. The method of claim 12 wherein said step of transmitting said duplicates of each accessed MP3 file to a virtual storage site is carried out by a virtual storage service provider by automatically transmitting a duplicate of each accessed file, in response to the accessing of each MP3 file to a selected one of said set of virtual storage sites on the Web wherein said duplicate MP3 files are stored as a virtual duplicate user personal MP3 collection among said set of virtual storage sites.

15. The method of claim 14 further including the step of tracking the distribution of said duplicate user collection among said set of virtual storage sites, and the activity of said user accessing said MP3 files by said virtual storage provider.

16. The method of claim 15 wherein:
said MP3 file source is a MP3 file provider on the Web; and
said MP3 file provider is also said virtual storage provider.

17. A computer program comprising a computer useable medium having a computer readable program for selecting and accessing MP3 audio/video files over a network, wherein the computer readable program when executed on a computer system causes the computer system to:
enable a user, via a first computer, to select and access MP3 files from a MP3 file source on a network;
store said accessed MP3 files as a user personal MP3 collection in association with said first computer;
responsive to the accessing of each of said MP3 files, also transmit a duplicate of each accessed file to a virtual storage site on the network and store said duplicate MP3 files at said site as a virtual duplicate user personal MP3 collection; and
play said audio/video MP3 files on a MP3 player including:
enable said user to access a selected portion of MP3 files from said personal collection through said first computer or from said virtual duplicate personal collection through an alternate computer; and
storing said selected portion of said MP3 files on said MP3 player.

18. The computer program of claim 17 wherein said duplicates of said accessed MP3 files are transmitted to said virtual storage site automatically in response to the accessing of said files from said network source.

19. The computer program of claim 18 wherein the playing of said MP3 files enables said user to access a selected portion of MP3 files from said personal collection through an alternate computer included in said MP3 player.

20. The computer program of claim 17 wherein said network is the World Wide Web.

21. The computer program of claim 20 wherein said alternate computer is any computer having access to the World Wide Web.

22. The computer program of claim 20 wherein said program causes said computer system to transmit said duplicates of each accessed MP3 file to a virtual storage site, under the control of a virtual storage service provider, by automatically transmitting a duplicate of each accessed file, in response to the accessing of each MP3 file to a selected one of said set of virtual storage sites on the Web wherein said duplicate MP3 files are stored as a virtual duplicate user personal MP3 collection among said set of virtual storage sites.

23. The computer program of claim 22 wherein said computer program further enables said virtual storage provider to track the distribution of said duplicate user collection among said set of virtual storage sites, and the activity of said user accessing said MP3 files.

24. The computer program of claim 23 wherein:
said MP3 file source is a MP3 file provider on the Web; and
said MP3 file provider is also said virtual storage provider.
